(19) United States
(12) Patent Application Publication
(10) Pub. No.: US 2009/0220089 A1
(43) Pub. Date: Sep. 3, 2009

(54) METHOD AND APPARATUS FOR MAPPING ENCRYPTED AND DECRYPTED DATA VIA A MULTIPLE KEY MANAGEMENT SYSTEM

(75) Inventors: Ashwin S. Venkatraman, Poughkeepsie, NY (US); Tara L. Astigarraga, Vall, AZ (US); Evren Ozan Baran, Highland, NY (US); Michael E. Browne, Staatsburg, NY (US); Christopher V. DeRobertis, Hopewell Junction, NY (US); Maria R. Ward, Pflugerville, TX (US)

Correspondence Address: INTERNATIONAL BUSINESS MACHINES CORPORATION;Richard Lau, IPLAW DEPARTMENT / Bldg 008-2, 2455 SOUTH ROAD - MS P386, POUGHKEEPSIE, NY, 12601, US

(73) Assignee: INTERNATIONAL BUSINESS MACHINES CORPORATION, Armonk, NY (US)

(21) Appl. No.: 12/039,247

(22) Filed: Feb. 28, 2008

(51) Int. Cl. H04L 9/06

(52) U.S. Cl. 380/277

(57) ABSTRACT

A method, apparatus and program product for encryption/decryption of data on a volume of data storage media including dividing the volume into a plurality of locations, assigning a unique key to each location for encryption/decryption of data in the respective location of the volume, mapping the locations and keys in the key manager, and encrypting/decrypting data on the volume based on the data's physical location on the volume. The owning entity owning each location on the volume may also be mapped, and the keys for each location owned by the same owning entity may be the same.

### FIELD OF THE INVENTION

This invention relates to providing access to information on data storage medium in a computer system, and particularly to providing access to a user by mapping encrypted and decrypted data via a key management system.

### BACKGROUND OF THE INVENTION

The current method of doing hardware tape encryption, and in the future, disk data encryption, requires that a volume be encrypted with a single key. This poses a problem in that when trying to share an encrypted tape or disk between two or more entities, the current procedure will require that all entities have access to the key to decrypt the data from the media device. Thus, all parties interested in their disparate data on the same encrypted tape or disk will have to come to an agreement for sharing the key. Another drawback is that if one entity's key is compromised, all of the data on the disk is also subject to being compromised. Also, every party interested in encrypting data may have their own tape or disk on which data is to be encrypted. Additionally once a key is compromised, all interested parties have to get a new key creating a potential progression of key management activities that will force the use of single party disk or tapes. With the ever increasing capacity of a unit of disk or tape having a single key per volume become less financially desirable.

U.S. Pat. No. 5,546,557 issued Aug. 13, 1996 to Allen et al. for SYSTEM FOR STORING AND MANAGING PLURAL LOGICAL VOLUMES IN EACH OF SEVERAL PHYSICAL VOLUMES INCLUDING AUTOMATICALLY CREATING LOGICAL VOLUMES IN PERIPHERAL DATA STORAGE SUBSYSTEM discloses a peripheral data storage subsystem for mounting and accessing smaller logical data-storage volumes from peripheral data storage.

U.S. Pat. No. 6,336,121 B1 issued Jan. 1, 2002 to Lyson et al. for METHOD AND APPARATUS FOR SECURING AND ACCESSING DATA ELEMENTS WITHIN A DATABASE discloses a method and apparatus for securing and accessing data elements within a database and is accomplished by securing a symmetric key based on an encryption public key.

U.S. Pat. No. 6,405,315 B1 issued Jun. 11, 2002 to Burns et al. for DECENTRALIZED REMOTELY ENCRYPTED FILE SYSTEM discloses a decentralized distributed file system based on a network of remotely encrypted storage. The disclosed system encrypts and decrypts at a data object level with metadata describing the directory structure of the file being encrypted.

US Patent Application Publication No. 2004/0161112 A1 published Aug. 19, 2004 by Kekinuma et al. for DATA RECORDING METHOD, DATA RECORDING SYSTEM, DATA RECORDING APPARATUS, DATA READING METHOD, ADAT READING SYSTEM, COUNTING METHOD, COUNTING SYSTEM, METHOD OF SUPPLYING ENCRYPTION KEY, SYSTEM FOR SUPPLYING ENCRYPTION KEY AND PROGRAM discloses data recorded in a recording medium encrypted with an encryption/decryption key, and the encryption/decryption key is encrypted with an decryption-only key to that key in a program for reading. The data cannot be read without the program for reading, and the program for reading cannot be used for recording other data, even if copied.

US Patent Application Publication No. 2005/0273861 A1 published Dec. 8, 2005 by Benaloh et al. for METHODS AND SYSTEMS OF PROTECTING DIGITAL CONTENT discloses a method of protecting digital content by partitioning it and uniquely marking and encryption each partition with a different key.

US Patent Application Publication No. 2006/0262927 A1 published Nov. 23, 2006 by Rutkowski et al. for SYSTEM AND METHOD FOR MANAGING ENCRYPTED CONTENT USING LOGICAL PARTITIONS discloses managing title keys by establishing logical partitions of title keys encrypted with the same binding information. Provided is a type of real-time, dynamic method or associating data with title keys and deciding whether or not certain elements are stale and/or need to be encrypted/re-encrypted.

International Application WO 81/00782 published 19 Mar. 1981 by Minnesota Mining and Manufacturing Company for HIGH CAPACITY DATA CARTRIDGE SYSTEM discloses a data recorder in which a preformatted tape is employed to enable automatic detection of the beginning of the tape and the end of the tape, as will as to location of preidentifiable record locations positioned along a plurality of parallel tracks. Also disclosed is using key patterns to enable control of the spatial location of data.

UK Patent Application No. GB 2 264 373 A published Aug. 25, 1993 by Eurologic Research Limited for DATA ENCRYPTION discloses an apparatus for encrypting data to be stored on a tape or other storage medium including encrypting different blocks of data using respective different keys which are derived from a common key as a function of the storage location of the data.

An article by Crowley for MERCY: A FAST LARGE BLOCK CIPHER FOR DISK SECTOR ENCRYPTION, Fast Software Encryption, 7th International Workshop, volume 1978 of Lecture Notes in Computer Science, pages 49-64 discloses a randomized block cipher accepting a 4096-bit block (a typical sector) designed specifically for the needs of disk sector encryption.

An article by Dowdeswell et al. for THE CRYPTOGRAPHIC DISK DRIVER, FREENIX Track 2003 USENIX Annual Technical Conference Proceeding, pp 17-168 (9-14 Jun. 2003), discloses a disk driver with encrypts an entire disk partition to protect against physical loss of data by theft or other unauthorized use on laptops or single user system/storage devices where protection from concurrent or multiple users is not an issue.

### SUMMARY OF THE INVENTION

It is a object of the present invention to provide a volume which is encrypted with a single key.

It is a further object of the present invention to allow different parts of a volume to be encrypted with different keys.

It is a further object of the present invention to provide for both secure data from disparate parties as well as insecure data to be stored on the same volume, requiring a smaller number of tapes needed to archive a particular set of data.

It is a further object of the present invention to provide for multiple keys to a data structure combination.

It is an additional object of the present invention to provide that the owning entities be added to the data structure with a method for describing key database operations to ensure no inappropriate entity and key relationships are disclosed.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a diagram of a system of the present invention;

FIG. 2 illustrates a key map data structure used in the system of FIG. 1;

FIG. 3 illustrates the flow of the present invention with the system of FIG. 1;

FIG. 4 is a flowchart of the functions performed by a storage management system of the system of FIG. 1; and

FIG. 5 is a flowchart of the functions performed by a key manager of the system of FIG. 1.

The detailed description explains the preferred embodiments of the invention, together with advantages and features, by way of example with reference to the drawings.

### DETAILED DESCRIPTION OF THE INVENTION

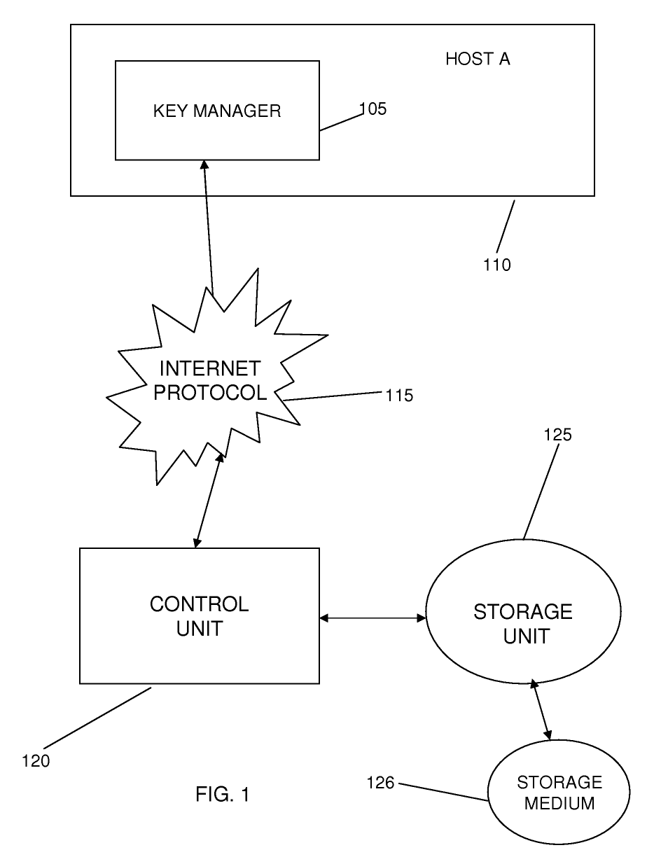

FIG. 1 depicts a data processing system having a host A 110 having a key manager 105 which stores the ranges of volume serial numbers and whether they are encrypted or not encrypted and which identifies the owning entity and defines access rights. A control unit 120 is connected by an IP connection 115 to the key manager 105. The control unit 120 controls a data storage unit 125, either a tape drive or a disk drive unit, which reads from and writes to storage medium 126, either a data tape or a disk. The data storage unit 125 includes an encryption facility for encrypting and decrypting the data on storage medium 126.

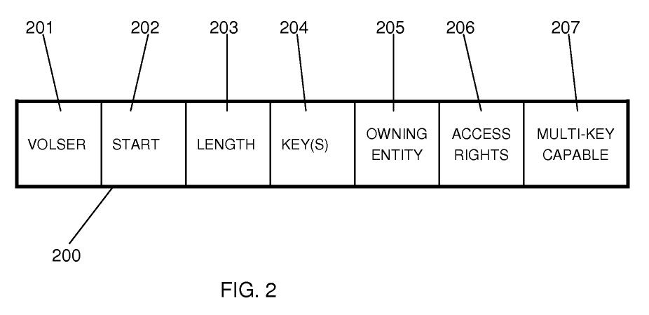

FIG. 2 illustrates a key map data structure stored and used by the key manager 105. The key map data structure includes a plurality of data records, one of which is shown in FIG. 2 as 200. Each data record 200 includes a serial number of the storage medium (VOLSER) 201, a Start field 202 which identifies the block to start read or write, a Length field 203 which identifies how long the user can read or write, Key(s) field 204 which identifies the key(s) to be used for encrypting/decrypting this section of the volume, Owning Entity(s) field 205 which identifies the owner of this section of the volume, and Access Rights field 206 which identifies the tape manager's access rights (read/write) to this section of the volume. Access rights are assigned by the Owning Entity(s). Each record 200 also includes a Multi-Key Capable field 207 which identifies if this volume is multi-key capable or not. The Multi-Key Capable field 207 provides for determining if multi-key operations and methods need to be performed. The keys are used as input to the encryption and decryption function in the drive. Each key is responsible for a portion of the data structure combination, as is well known in the art and will not be described further.

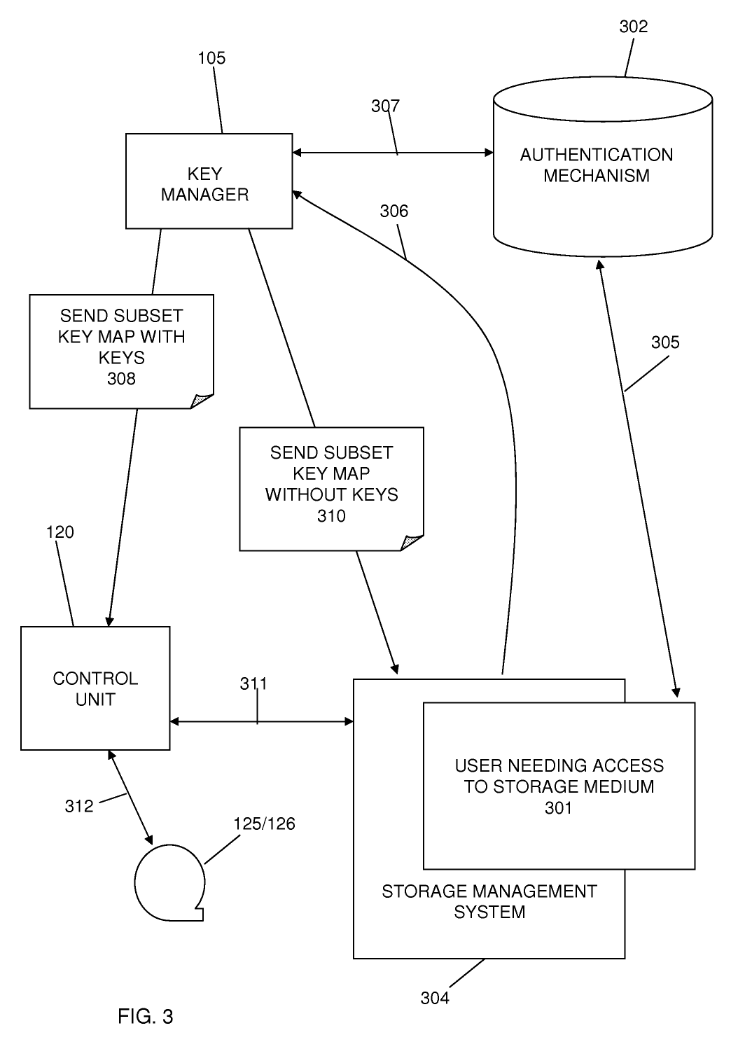

FIG. 3 illustrates the flow of the present invention with the system of FIG. 1 with only part of the system shown. The authentication provider 302 provides authentication credentials at 305 for a user 301 needing access to the storage medium 126. The authentication mechanism 302 may be, for instance, Kerberos software, which is well understood in the art and will not be discussed further. A storage management system 304, acting on the user's behalf, sends requests for storage medium 126 and key map at 306 to the key manager 105. The storage management system 304 may be, for instance, the Tivoli Storage Manger (TSM) available from International Business Machines. The key manager 105 verifies the credentials sent by the user 301 with the authentication mechanism 302 at 307. The key manager 105 then creates a subset of medium's Key Map (see FIG. 2), including the keys associated with the section that belongs to the user, and sends it to the control unit 120 at 308. The key manager 105 then takes the same subset of 308 not including any keys, and, at 310, sends it to the storage management system 304 for the user 301 who requested the storage medium. The user 301, using the storage management system 304, retrieves at 311, the information from the storage medium 126 at 312 through the control unit 120. It will be understood that each key used to encrypt different parts of the volume may be totally unique for each other. However, keys for different parts of the volume owed by the same user may be the same. Further, encrypting and decrypting of data is based on the physical location of the data in a volume with a plurality of keys stored and mapped in the key manager 105. It will be understood that the storage medium 126 may be either tape or disk, or any other storage medium.

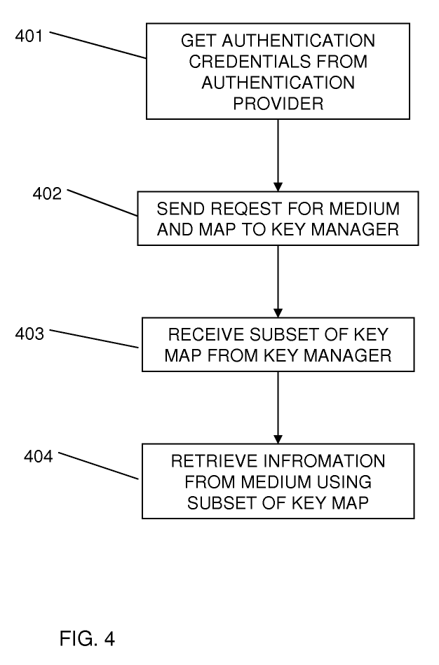

FIG. 4 is a flowchart of the functions performed by the storage management system 304. At 401, the storage management system gets authentication credentials from the authentication provider 302 for the user 301. At 402, a request is sent to the key manager 105 requesting the storage medium and key map. At 403, a subset of medium's key map is received without keys. At 404, the user retrieves information for the medium 126 through the control unit 120.

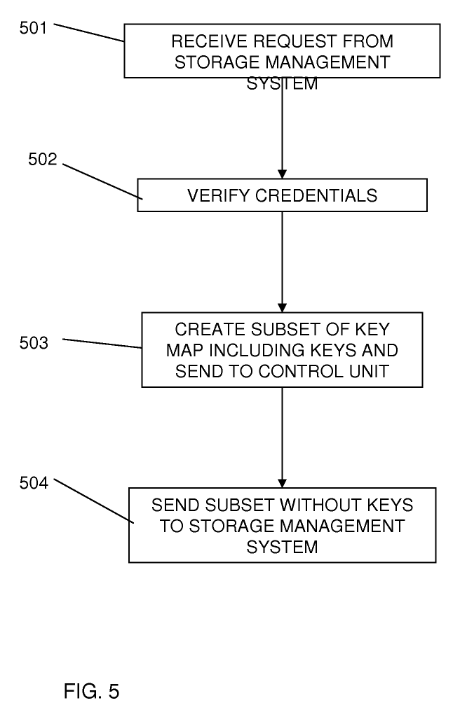

FIG. 5 is a flowchart of the functions performed by the key manager 105. At 501, the key manager 105 receives a request from the storage management system sent at step 402 of FIG. 4, the request requesting the storage medium and key map for user 301. At 502, the credentials are verified with the authentication mechanism. At 503, the key manager 105 creates a subset of the key map including keys associated with the section that belongs to the user 301 and sends it to the control unit 120. At 504, the key manager 104 sends the subset without the keys to the storage management system to be used to retrieve information at step 404 of FIG. 4.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for encryption/decryption of data on a volume of data storage media comprising;
dividing the volume into a plurality of locations;
assigning a unique key to each location for encryption/decryption of data in the respective location of said volume;
mapping said locations and keys in said key manager; and
encrypting/decrypting data on said volume based on the data's physical location on the volume.

2. The method according to claim 1 further comprising:
mapping in the key manager, the owning entity of the data at each location of said volume.

3. The method of claim 2 further comprising:
assigning the same key to the locations owned by the same entity.

4. The method according to claim 1 further comprising:
mapping the access rights of each location of said volume; and
controlling the access to said locations in accordance with the mapped access rights granted for said locations.

5. The method according to claim 1 further comprising:
granting access to a user needing access to said volume by an authentication mechanism such that only users having the proper authentication credentials may access a location on said volume.

6. The method according to claim 1 further comprising:
sending a subset of the key map with keys from the key manager to a control unit controlling encryption/decryption of data on said volume; and
sending the subset of the key map without keys from the key manager to a storage management system for reading or writing data on said volume via said control unit.

7. The method according to claim 6 wherein said storage management system is the Tivoli Storage Manager.

8. A system for encryption/decryption of data on a data storage media comprising;
a volume of the data storage media divided into a plurality of locations;
a key manager connected to said storage management system, said key manager assigning a unique key to each location for encryption/decryption of data in the respective location of said volume;
a mapping function in said key manager mapping said locations and keys; and
a control unit connected to said key manager encrypting/decrypting data on said volume based on the data's physical location on the volume.

9. The system according to claim 8 further comprising:
said mapping function mapping in the key manager, the owning entity of the data at each location of said volume.

10. The system of claim 9 further comprising:
said key manager assigning the same key to the locations owned by the same entity.

11. The system according to claim 8 further comprising:
said mapping function mapping the access rights of each location of said volume; and
said control unit controlling access to said locations in accordance with the mapped access rights granted for said locations.

12. The system according to claim 8 further comprising:
said key manager granting access to a user needing access to said volume by an authentication mechanism such that only users having the proper authentication credentials may access a location on said volume.

13. The system according to claim 8 further comprising:
said key manager sending a subset of the key map with keys from the key manager to a control unit controlling encryption/decryption of data on said volume; and
said key manager sending the subset of the key map without keys from the key manager to a storage management system for reading or writing data on said volume via said control unit.

14. The system according to claim 13 wherein said storage management system is the Tivoli Storage Manager.

15. A program product usable with a system for encryption/decryption of data on a volume of data storage media comprising;
a computer readable medium having recorded thereon computer readable program code performing the method comprising:
dividing the volume into a plurality of locations;
assigning a unique key to each location for encryption/decryption of data in the respective location of said volume;
mapping said locations and keys in said key manager; and
encrypting/decrypting data on said volume based on the data's physical location on the volume.

16. The program product according to claim 15 wherein said method further comprises:
mapping in the key manager, the owning entity of the data at each location of said volume.

17. The program product of claim 16 wherein said method further comprises:
assigning the same key to the locations owned by the same entity.

18. The program product according to claim 15 wherein said method further comprises:
mapping the access rights of each location of said volume; and
controlling the access to said locations in accordance with the mapped access rights granted for said locations.

19. The program product according to claim 15 wherein said method further comprises:
granting access to a user needing access to said volume by an authentication mechanism such that only users having the proper authentication credentials may access a location on said volume.

20. The program product according to claim 15 wherein the method further comprises:
sending a subset of the key map with keys from the key manager to a control unit controlling encryption/decryption of data on said volume; and
sending the subset of the key map without keys from the key manager to a storage management system for reading or writing data on said volume via said control unit.
